(19) United States
(12) Patent Application Publication
(10) Pub. No.: US 2003/0037424 A1
(43) Pub. Date: Feb. 27, 2003

(54) Method of forming a tubular axle

(76) Inventor: David K. Platner, Shelby, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/935,026

(22) Filed: Aug. 22, 2001

(51) Int. Cl. B23P 17/00

(52) U.S. Cl. 29/421.1

(57) ABSTRACT

A method of forming a tubular axle assembly is provided. The method includes providing a non-circular tubular member such as a rectangular tube having an end portion. The end portion is formed to provide a first generally circular end. A king pin boss is provided with a second generally circular end of approximate the same size as the first generally circular end. The two ends are friction welding together, and the tubular member are bent to a desired axle shape. In addition, a bulk head may be inserted into the tubular member prior to forming the end portion. The first circular end is preferably formed by a swaging or pointing process to reduce the cross-sectional area of the tubular member and form the circular end. The axle may then be processed by heat treating, quenching, and tempering the axle. Straightening of the axle may also be desirable.

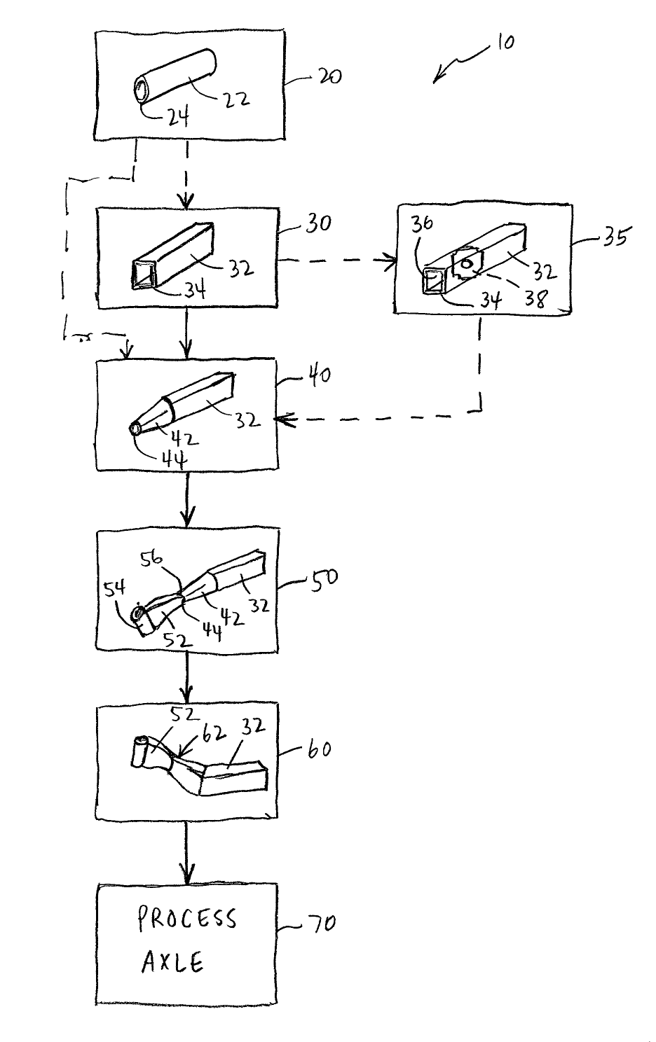

### BACKGROUND OF THE INVENTION

This invention relates to a tubular axle for use as a front or steer axle, and more particularly, the invention relates to a method of attaching a king pin boss to a tubular member and forming the axle.

Front axles are typically constructed from a forged I-beam, which is suitable for bending loads but typically undesirable for torsional loads. Hollow tubular members have been used to lighten the axle and improve the torsional loading characteristics of the axle. Specifically, rectangular or cylindrical tubes have been used with goose necks butt welded to the ends of the tube. The end of the goose neck includes a provisional for a king pin. The king pins provide the pivotal attachment for steering knuckles, which support the vehicle wheels. However, butt welding is undesirable in that it is an expensive process and can be a difficult process to control.

Therefore, what is needed is a light weight axle with sufficient torsional stiffness having an inexpensive and simple method of attaching the king pin boss to the axle beam.

### SUMMARY OF THE INVENTION AND ADVANTAGES

The present invention provides a method of forming a tubular axle assembly. The method includes providing a non-circular tubular member such as a rectangular tube having an end portion. The end portion is formed to provide a first generally circular end. A king pin boss is provided with a second generally circular end of approximately the same size as the first generally circular end. The two ends are friction welding together, and the king pin and tubular member are bent to a desired axle shape. In addition, a bulk head may be inserted into the tubular member prior to forming the end portion. The first circular end is preferably formed by a swaging or pointing process to reduce the cross-sectional area of the tubular member and form the circular end. The axle may then be processed by heat treating, quenching, and tempering. Straightening of the axle may also be desirable.

Accordingly, the above invention provides a light weight axle with sufficient torsional stiffness having an inexpensive and simple method of attaching the king pins to the axle beam.

### BRIEF DESCRIPTION OF THE DRAWINGS

Other advantages of the present invention can be understood by reference to the following detailed description when considered in connection with the accompanying drawing wherein the FIGURE is a flowchart of the present invention forming process depicting the axle at its various forming stages.

### DETAILED DESCRIPTION OF THE PREFERRED EMBODIMENT

A flow chart of the present invention axle forming process 10 is shown in the FIGURE. The process 10 includes providing a non-circular tubular member, preferably a rectangular tube, as indicated at 30. The tubular member 32 includes an end portion 34. It is to be understood that the tubular member 32 may be provided by hydroforming a cylindrical member 22 having a circular end 24, as indicated at 20. If desired, a bulkhead 38 maybe inserted into a cavity 36 of the square blank 32 to reinforce the axle in that area, as indicated at 35. The bulkhead 38 better withstands the clamping loads in that area.

The end of tubular member 32 is formed, preferably by a swaging or pointing process, to provide a first circular end 44 that has a diameter smaller than the width of the tubular member 32. The swaging process may produce a frustoconical portion 42 tapering from the tubular member 32 to the circular end 44. It is to be understood that the tubular member 32 with frustoconical portion 42 may be provided by hydroforming a cylindrical member 22. A king pin boss 52 is provided having a pivotal connection 54 and a second circular end 56 opposite the pivotal portion. The pivotal connection 54 provides an attachment point for a knuckle. The circular ends 44 and 56 are approximately the same size which enables the ends 44 and 56 to be friction welded together in a manner known in the art. The king pin 52 and tubular member 32 are secured together by a friction weld, as indicated at 50. The tubular member 32 and king pin 52 may be bent to a desired shape, as indicated at 60. Bending the tubular members 32 and 42 may yield a trapezoidal cross-sectional in the frustoconical area 42.

The axle may then be processed in any manner typically used. In particular, the axle may be heat treated in a furnace and then quenched at a desired rate. The axle may then be tempered and straightened, if necessary.

In this manner, a hollow tubular member may be used, which lightens the axle and provides desirable bending and torsional loading characteristics. Furthermore, by providing circular ends on the tubular member and king pin, a friction welding process may be used which reduces the cost and improves the manufacturability of the axle.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A method of forming a tubular axle comprising the steps of:
a) providing a non-circular tubular member having an end portion;
b) forming the end portion to provide a first generally circular end;
c) providing a kingpin boss with a second generally circular end; and
d) friction welding the ends together.

2. The method according to claim 1, further including the step of bending the tubular portion to a desired shape subsequent to step d).

3. The method according to claim 1, further including the step of inserting a bulkhead into a cavity of the tubular member prior to step b).

4. The method according to claim 1, further including the step of hydroforming a hollow cylindrical member into the non-circular tubular member prior to step a).

5. The method according to claim 1, wherein step a) includes providing a noncircular end portion.

6. The method according to claim 1, wherein step b) includes forming the end portion into a generally conical shape.

7. The method according to claim 1, wherein step b) includes providing the first end with a diameter smaller than a width of the tubular member.

8. The method according to claim 1, further including the step of heat treating the axle.

9. The method according to claim 8, further including the step of quenching the axle.

10. The method according to claim 9, further including the step of tempering the axle.

11. The method according to claim 8, further including the step of straightening the axle.

12. The method according to claim 1, wherein the circular ends are generally the same size.
